(19) United States
(12) Patent Application Publication
(10) Pub. No.: US 2018/0025824 A1
(43) Pub. Date: Jan. 25, 2018

(54) ELECTROMAGNETIC ACTUATOR

(71) Applicant: K.A. Advertising Solutions Ltd., Yokneam Hit (IL)

(72) Inventors: Arnon KRAEMER, Zikhron-Yaakov (IL); Avishai YOSSIPOVITCH, Kiryat-Bialik (IL); Michael YAROKER, Migdal HaEmek (IL); llan GRUNBERG, Haifa (IL)

(21) Appl. No.: 15/547,825

(22) PCT Filed: Feb. 1, 2016
(86) PCT No.: PCT/IL2016/050109

§ 371 Date: Aug. 1, 2017

Related U.S. Application Data
(60) Provisional application No. 62/110,557, filed on Feb. 1, 2015.

(51) Int. Cl. H01F 7/16

(52) U.S. Cl. CPC H01F 7/1638

(57) ABSTRACT

An electromagnetic actuator device, the device including an electromagnet including a coil, and a magnetic core including a first portion extending from a front face of the coil, and a second portion extending from a back face of the coil bending back along the coil toward the front face of the coil, and a plate placed such that a first portion of the plate parallels the first portion of the magnetic core and a second portion of the plate parallels the second portion of the magnetic core. Related apparatus and methods are also described.

### RELATED APPLICATION/S

This application is a PCT Application claiming priority of U.S. Provisional Patent Application No. 62/110,557 filed 1 Feb. 2015.

The contents of all of the above applications are incorporated by reference as if fully set forth herein.

### FIELD AND BACKGROUND OF THE INVENTION

The present invention, in some embodiments thereof, relates to an electromagnetic actuator, and, more specifically but not exclusively, to an electromagnetic actuator which applies force on a plate using both magnetic poles across two gaps, and, even more specifically but not exclusively, causes movement of the plate in a direction perpendicular to an axis of a coil.

An electromagnet is a type of magnet in which the magnetic field is produced by an electric current. The magnetic field disappears when the current is turned off. Electromagnets usually consist of a large number of closely spaced turns of wire, called a coil, that produce the magnetic field. The wire turns are often wound around a magnetic core made from a ferromagnetic or ferrimagnetic material such as iron; the core concentrates the magnetic flux and makes a more powerful magnet.

Additional background art includes U.S. Patent Application Publication Number 2013/0258442 of Kraemer et al.

The disclosures of all references mentioned above and throughout the present specification, as well as the disclosures of all references mentioned in those references, are hereby incorporated herein by reference.

### SUMMARY OF THE INVENTION

An aspect of some embodiments includes an electromagnetic actuator which effects force on one plate using both magnetic poles across two gaps.

An aspect of some embodiments includes an electromagnetic actuator which effects force perpendicularly to an axis of an electromagnetic coil.

An aspect of some embodiments includes extending a core so as to protrude from a front end of a coil, and using the external portion of the core to concentrate magnetic lines and pull a ferromagnetic or ferrimagnetic material, sideways, across an air gap.

An aspect of some embodiments includes extending a core so as to protrude from a back end of the coil and fold back parallel to the coil, and pull a ferromagnetic or ferrimagnetic material sideways, across two air gaps.

An aspect of some embodiments includes an electromagnetic actuator which produces a significant force at its moving part, when applying a relatively low voltage or current, using both magnetic poles across two gaps.

According to an aspect of some embodiments of the present invention there is provided an electromagnetic actuator device, the device including an electromagnet including a coil, and a magnetic core including a first portion extending from a front face of the coil, and a second portion extending from a back face of the coil bending back along the coil toward the front face of the coil, and a plate placed such that a first portion of the plate parallels the first portion of the magnetic core and a second portion of the plate parallels the second portion of the magnetic core.

According to some embodiments of the invention, the second portion of the magnetic core extends from a back face of the coil and folds back along the coil toward the front face of the coil.

According to some embodiments of the invention, the plate is arranged to be pulled in a direction perpendicular to a longitudinal axis of the coil.

According to some embodiments of the invention, the plate is connected to the electromagnet by a spring, which is configured to keep the plate separate from the magnetic core.

According to some embodiments of the invention, the second portion of the magnetic core extends from the back face of the coil and bends toward the front face of the coil in a direction parallel to a longitudinal axis of the electromagnet.

According to some embodiments of the invention, the first portion of the plate includes at least a fifth of the plate length. According to some embodiments of the invention, the second portion of the plate includes at least a fifth of the plate length.

According to some embodiments of the invention, the first portion of the plate is positioned across a first gap from the first portion of the magnetic core and the second portion of the plate is positioned across a second gap from the second portion of the magnetic core.

According to some embodiments of the invention, the first gap is equal in width to the second gap. According to some embodiments of the invention, the first gap is unequal in width to the second gap.

According to some embodiments of the invention, the first portion of the plate is substantially parallel to the first portion of the magnetic core and the second portion of the plate is substantially parallel to the second portion of the magnetic core.

According to some embodiments of the invention, the plate has a range of movement of at least 20% of a dimension of the electromagnetic actuator in the direction of movement. According to some embodiments of the invention, the plate has a range of movement of at least 35% of a dimension of the electromagnetic actuator in the direction of movement.

According to some embodiments of the invention, the plate includes a zigzag shape in which a first portion of the zigzag shape is the first portion of the plate and a second portion of the zigzag shape is the second portion of the plate.

According to some embodiments of the invention, a length of a middle portion of the zigzag shape, connecting the first portion and the second portion, has a length greater than a difference between a distance of the first portion from a longitudinal axis of the coil and a distance of the second portion from a longitudinal axis of the coil.

According to some embodiments of the invention, further including a bobbin on which the coil is wound, the bobbin including a lengthwise lumen, through which the core passes.

According to some embodiments of the invention, the bobbin further includes a trough on a front face, at the front face end of the coil, for accepting the second extension of the magnetic core.

According to some embodiments of the invention, the electromagnet achieves a force of at least 6×10-4 Newton exerted on the plate when a voltage of 5 volts is applied to the coil.

According to some embodiments of the invention, the electromagnet has H×W×L dimensions smaller than 10 mm×5 mm×30 mm respectively.

According to an aspect of some embodiments of the present invention there is provided an electromagnetic actuator device, the device including an electromagnet including a coil, and a magnetic core including a first portion extending from a front face of the coil, and a second portion extending from a back face of the coil bending back along the coil toward the front face of the coil, and a zigzag shaped plate placed such that a first leg of the zigzag shaped plate parallels the first portion of the magnetic core and a second leg of the zigzag shaped plate parallels the second portion of the magnetic core.

According to an aspect of some embodiments of the present invention there is provided a method of operating an electromagnetic actuator, including providing electric power to a coil, producing a magnetic field within a magnetic core, a first portion of the magnetic core, extending from a first face of the coil, exerting a first magnetic attraction force on a first portion of a plate, and a second portion of the magnetic core, extending from a second face of the coil, exerting a second magnetic attraction force on a second portion of the plate, wherein the first magnetic attraction force and the second magnetic attraction force are in a same direction, thereby exerting two magnetic attraction forces in a same direction on the plate.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are simplified illustrations of prior art electromagnetic actuators;

FIGS. 2A and 2B are simplified illustrations of example embodiments of the invention;

FIGS. 3A and 3B are simplified cross sectional drawings of an example embodiment of the invention;

FIG. 4 is a simplified cross sectional drawing of an aspect of an example embodiment of the invention;

FIGS. 5A and 5B are simplified cross sectional drawings of another aspect of an example embodiment of the invention;

FIG. 6 is a simplified cross sectional drawing of another example embodiment of the invention;

FIGS. 7A and 7B are simplified cross sectional drawings of another aspect of an example embodiment of the invention;

FIGS. 8A and 8B are simplified cross sectional drawings of another aspect of an example embodiment of the invention; and

FIG. 9 is a flow chart illustration of a method of operating an electromagnetic actuator according to an example embodiment of the invention.

### DESCRIPTION OF SPECIFIC EMBODIMENTS OF THE INVENTION

The present invention, in some embodiments thereof, relates to an electromagnetic actuator, and, more specifically but not exclusively, to an electromagnetic actuator which applies force on a plate using both magnetic poles across two gaps, and, even more specifically but not exclusively, causes movement of the plate in a direction perpendicular to an axis of a coil.

The terms “plunger” and “plate” are used interchangeably in the specification to indicate an object pulled magnetically toward an electromagnet.

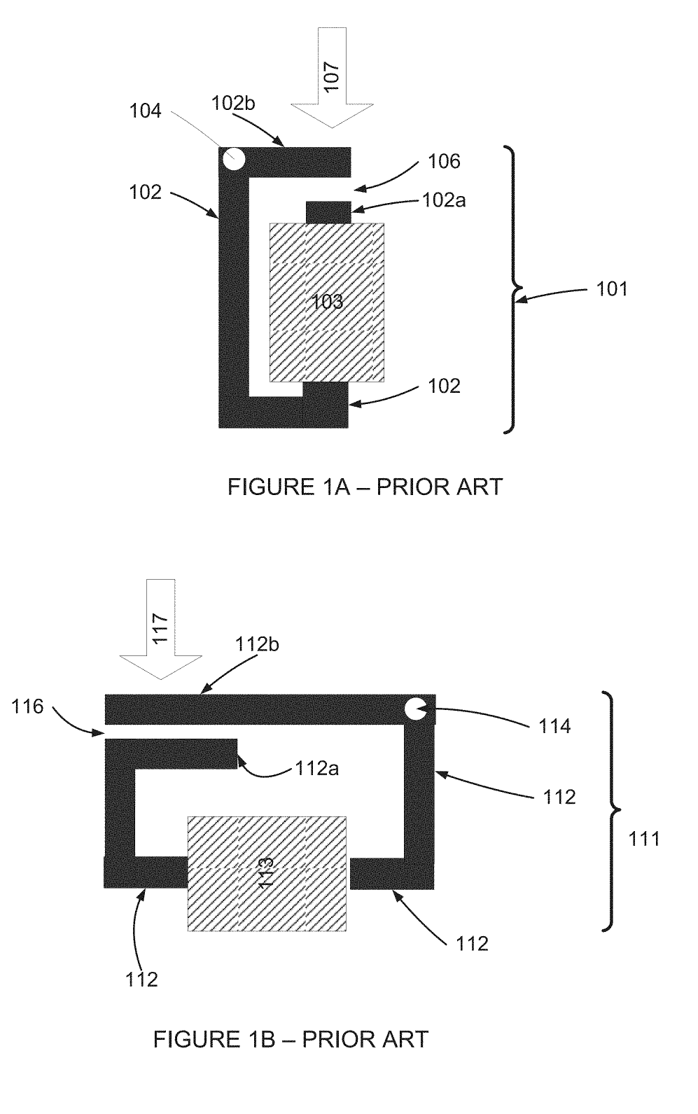

For purposes of better understanding some embodiments of the present invention, reference is first made to FIGS. 1A and 1B, which are simplified illustrations of prior art electromagnetic actuators.

FIG. 1A depicts an electromagnet 101 having a core 102 including a hinge 104, and a coil 103 surrounding the core 102.

In the example of FIG. 1A the core 102 is shaped such that one pole 102a of the core 102 is across a gap 106 from the other pole 102b, and the other pole 102b is flexibly continuous to the core 102 by the hinge 104. The hinge 104 may include a spring to keep the gap 106 open and the pole 102b away from the pole 102a when current is not flowing through the coil 103. The core 102a 102 102b makes up a continuous metal path for magnetic field lines.

When electricity is caused to flow through the coil 103 of the electromagnet 101 electromagnetic force 107 is exerted on the pole 102b to close the gap 106.

It is noted that the design of the electromagnetic actuator depicted in FIG. 1A maintains a continuity of metal through the pole 102a, the core 102, the hinge 104 and the core 102b.

In the example of FIG. 1B the core 112 is shaped such that one pole 112a of the core 112 is across a gap 116 from the other pole 112b, and the other pole 112b is flexibly continuous to the core 112 by the hinge 114. The hinge 114 may include a spring to keep the gap 116 open and the pole 112b away from the pole 112a when current is not flowing through the coil 113. The core 112a 112 112b makes up a continuous metal path for magnetic field lines.

When electricity is caused to flow through the coil 113 electromagnet 111 electromagnetic force 117 is exerted on the pole 112b to close the gap 116.

In some cases, especially when a deep cavity cannot be afforded due to design considerations, or when electromagnetic force maximization is desired, a wide and shallow coil is used. However, in such cases electromagnetic actuators cannot be packed with their faces densely adjacent to each other, as the coils are broad.

An aspect of some embodiments includes extending a core so as to protrude from an end of a coil, and using the external portion of the core to concentrate magnetic lines and pull a ferromagnetic or ferrimagnetic material sideways, across a small air gap.

An aspect of some embodiments includes extending a core so as to protrude from an end of a coil and bend back parallel to the coil, and pull a plate of ferromagnetic or ferrimagnetic material sideways, by both poles of an electromagnet across two small air gaps.

The term “parallel” is used throughout the present specification and claims to mean substantially parallel, for example parallel up to a small deviation from exactly parallel, such as within 20 degrees from exactly parallel. For example, the term parallel is used to describe a plate parallel to a magnetic pole, and the parallelism may be within 20 degrees.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

An aspect of some embodiments of the invention includes using an electromagnet to pull a plate or plunger sideways to its axis, potentially enabling use of a thin electromagnet in a thin enclosure, yet still using a relatively long electromagnet to achieve relatively great pulling force.

An aspect of some embodiments includes a electromagnetic actuator which produces a significant force at its moving part, when applying a relatively low voltage or current, as compared with conventional electromagnetic actuators.

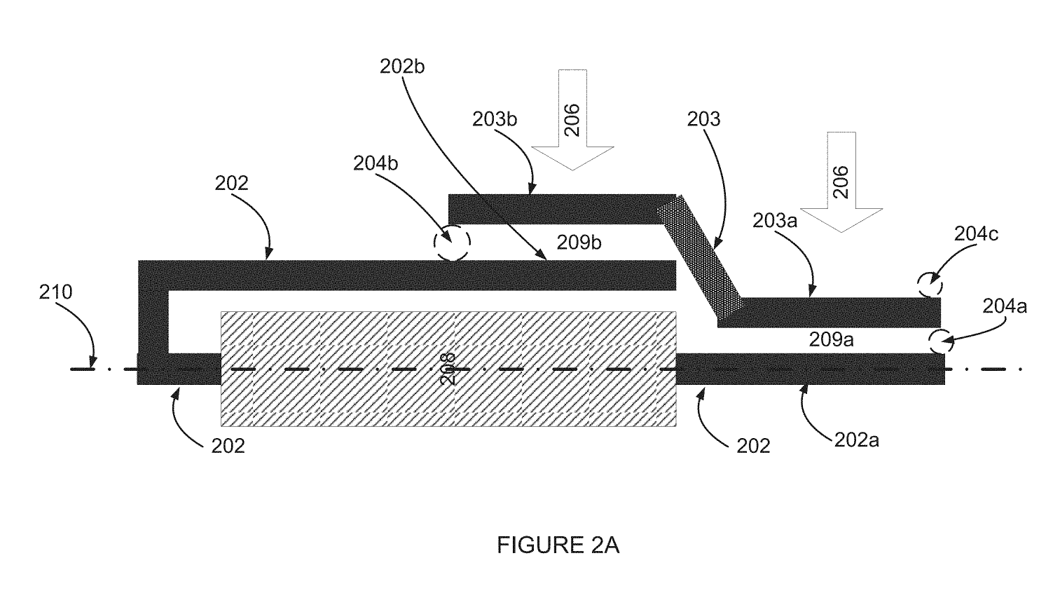

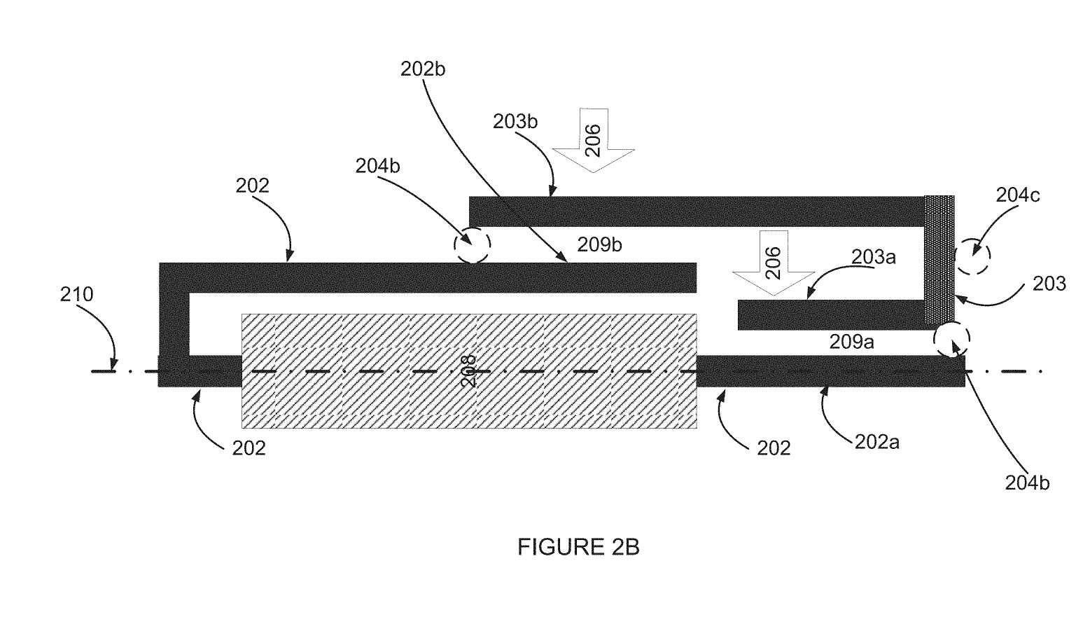

Reference is now made to FIGS. 2A and 2B, which are simplified illustrations of example embodiments of the invention.

FIGS. 2A and 2B depict an electromagnet including a coil 208, a core 202, and a plate 203, which together depict an example embodiment of an electromagnetic actuator.

In some embodiments the electromagnetic actuator includes a spring, which may optionally attach the plate 203 to the core 202. In some embodiments the spring is not connected to the core 202. Two non-limiting optional example locations of the spring 204a 204b are depicted in FIGS. 2A and 2B. Two non-limiting optional example locations of the spring 204c which are not attached to the core 202 are also depicted in FIGS. 2A and 2B.

In some embodiments the plate 203 may be termed a floating plate, positioned across two gaps 209a 209b from poles 202a 202b of the electromagnet. In various embodiments the plate 203 may be connected to the core 202 at various locations, or not connected to the core at all.

FIGS. 2A and 2B depict an electromagnet configured to pull the plate 203 sideways relative to a longitudinal axis 210 of the electromagnetic coil 208.

When current flows through the coil 208, the plate 203 gets pulled across the two gaps 209a 209b between the plate 203 and the core 202, in a direction approximately perpendicular to the axis 210 of the electromagnet, as depicted by the arrows 206.

In some embodiments the plate 203 includes three portions: a first portion 203a across a gap 209a from one electromagnetic pole 202a, a second portion 203b across a gap 209b from a second electromagnetic pole 202b, and optionally a third, optionally middle portion, connecting the first portion 203a of the plate 203 and the second portion 203b of the plate 203.

The plate may be made of three distinct portion as described above, or with a design of one plate which is positioned so as to have at least the first portion 203a and the second portion 203b across the gaps 209a 209b from two magnetic poles 202a 202b of the electromagnet.

A shape of the plate 203 may optionally be staggered, having somewhat of a zigzag shape or S-shape, similarly to the shape depicted in FIG. 2A; or the plate 203 may be shaped as a flat plane, optionally with the core pole 202a 202b arranged in parallel with the plane of the plate 203.

In some embodiments, as depicted in FIG. 2B, a shape of the plate 203 may optionally be bent, having somewhat of a U-shape.

The gaps 209a and 209b may be equal, that is the plate portion 203a may be equally distant from the pole 202a as the plate portion 203b from the pole 202b, or the gaps may be unequal.

The plate 204 of FIGS. 2A and 2C is pulled toward the poles 202a 202b of the core at a direction perpendicular to a direction of a longitudinal axis of the coil 208.

In some embodiments (not shown), the poles 202a 202b may be extended and/or bent so as to be perpendicular to the longitudinal axis of the coil 208, and in such embodiments the plate 204 may be pulled toward the poles 202a 202b of the core at a direction parallel to the direction of a longitudinal axis of the coil 208.

Material making up the plate may be ferromagnetic, or ferrimagnetic. The first and second portions of the plate may be made of a material as above, for magnetic attraction, and may even be connect by a non-magnetic material.

The plate may optionally be coated, on a side pulled against the magnetic poles or on all sides, by a coating. The coating may serve for softening impact or noise of the plate against the magnetic poles.

An optional embodiment of the spring is drawn as a spring 204b, attaching the plate portion 203b to the core pole 202b. In some embodiments a spring 204a may optionally attach the plate portion 203a to the core pole 202a. In some embodiments the spring 204a 204b may pull on the plate away from the poles, and/or push the plate away from the poles, and/or be attached elsewhere (spring 204c), not necessarily to a part of the core 202.

In some embodiments, material making up the spring 204 may optionally be not conductive of magnetic field lines, such as a plastic or rubber or nylon or synthetic spring, or even a metallic spring which is not especially conductive of magnetic lines such as, by way of a non-limiting example, brass.

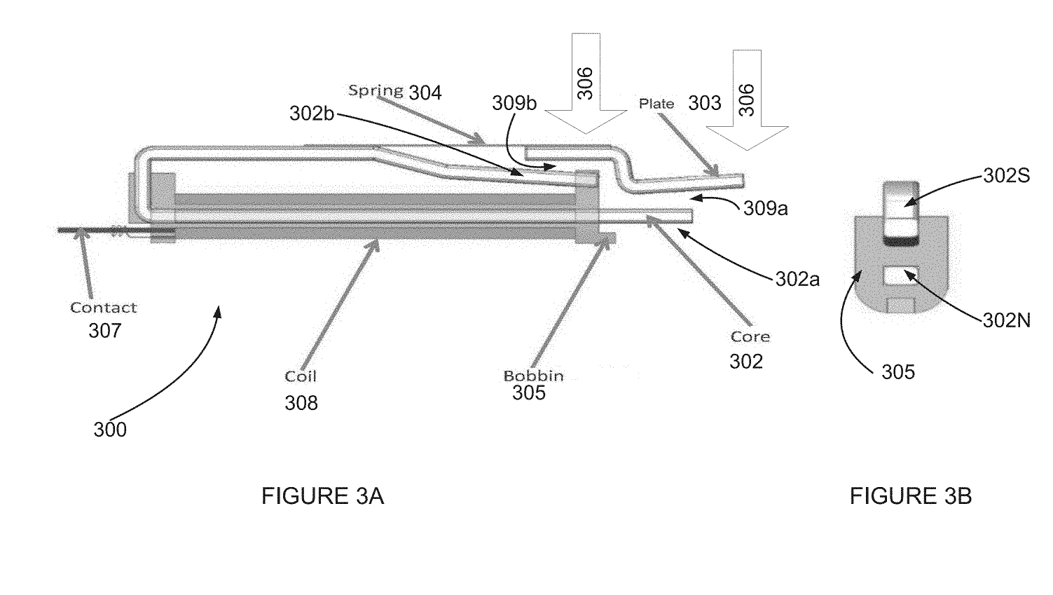

As described above with reference to attachment locations, of the spring 204, operation of the electromagnetic actuator described with reference to FIGS. 2A, 2B and 3A and to other embodiments of the invention described herein optionally operates without the plate in magnetic field line continuity with the magnetic core.

It is noted that the design of the electromagnetic actuator depicted in FIGS. 2A, 2B and 3A does not necessarily maintain a continuity of metal through the core 202, the spring 204 and the plate 203, and in a preferred embodiment does not maintain the continuity of metal.

In some embodiments the coil 201 is optionally wrapped around a bobbin 205 (not shown).

Reference is now made to FIGS. 3A and 3B, which are simplified cross sectional drawings of an example embodiment of the invention.

FIG. 3A depicts an electromagnet configured to pull a plate, using both magnetic poles, across two gaps, potentially increasing a pulling force for a same application of current.

FIG. 3A depicts the electromagnet optionally configured to pull the plate sideways, perpendicularly to a longitudinal axis of the electromagnet.

It is noted that pulling a plate using both magnetic poles, across two gaps, potentially increasing a pulling force for a same application of current, and may also enable exerting a same force across larger gaps for the same application of current.

FIG. 3A depicts an electromagnet 300 including a coil 308, and a core 302, and a plate 303 attached to a spring 304, which together depict a example embodiment of an electromagnetic actuator.

When current flows through the coil 308, the plate 303 gets pulled across two gaps 309a 309b; a first gap 309a between the plate 303 and one pole 302a of the core 302, and a second gap 309b between the plate 303 and an extension 302b of the core 302 which extends out of an opposite magnetic pole and is bent back along the electromagnetic coil 308 toward the plate 303. The electromagnet 300 pulls the plate 303 across both gaps 309a 309b in a same direction approximately perpendicular to a longitudinal axis of the electromagnet 300 as depicted by two arrows 306 in FIG. 3A.

The electromagnetic actuator depicted in FIG. 3A may optionally be unique in shape. The plate 303 is optionally designed so as to implement two gaps between the plate 303 and two magnetic poles 302a 302b of the core 302, by way of a non-limiting example as a folded shape, such as a zigzag shape depicted in FIG. 3A. The zigzag shape enables closing the magnetic field at its two poles, so the plate 303 is pulled towards a stator (the core 302) at both of the stator's poles, which potentially can double an attraction force for a same electric power expenditure.

It is noted that in some embodiments the plate 303, by virtue of proper design, can provide a benefit of maintaining the gaps 309a 309b of equal distance when open, during being attracted to the core 302a 302b all the way up to making contact with the core 302a 302b.

It is noted that a straight plate 303 may also be used, although in some of such cases the gap 309a 309b may not be equal.

In some embodiments the core 302 is optionally U-shaped, having a first portion long enough to extend from the coil 308, and a second portion long enough to extend from a back face of the coil 308 and bend back toward a front face of the coil 308.

In some embodiments the coil 308 may be made of 30 micron diameter copper wire, at 5700 turns, for a total resistance of 1000 ohms.

In some embodiments the electromagnet is designed to operate at a voltage of 5 volts, and the above numbers are considered potentially especially suitable for 5 volt operation.

It is noted that other appropriate wire types may be chosen with a different cross section, such as 10 microns to 200 microns, suitable for the total length and resistance of the coil, as may be calculated by a person skilled in the art.

It is noted that appropriate wire types may be chosen with various insulation coatings as may be selected by a person skilled in the art.

In some embodiments the core 308 is optionally a metal core, optionally a ferromagnetic core, optionally an iron core, optionally a galvanized iron core.

In some embodiments the plate 303 is optionally a metal plate, optionally a ferromagnetic plate, optionally an iron plate, optionally a galvanized iron plate, or optionally a ferrimagnetic plate.

Electrically conductive wire is optionally wound around a bobbin, in some embodiments optionally made of a plastic material, which potentially provides an ability to connect the electromagnet 300 accurately to one or two or even more connector contact(s) with one or more contact 307 pin(s) or contact 307 shaft(s).

In some embodiments the contact(s) 307 may optionally be attached to a plastic bobbin during a molding process.

In some embodiments the contact(s) may have a cross section of 0.4 mm in diameter. In some embodiments the contacts may be of 0.3 mm diameter, 0.4 mm, 0.5 mm, 0.6 mm, 0.7 mm, 0.8 mm and higher. In some embodiments the contacts may have a rectangular cross section, such as 0.2 mm×0.2 mm, 0.3 mm×0.3 mm, 0.4 mm×0.4 mm, 0.5 mm×0.5 mm, 0.6 mm×0.6 mm or larger, of equal or of different width and height.

A potential benefit of the bobbin 305 shape includes a simple way to connect ends of electric wire of the coil 308 to the contact(s) 307.

It is noted that in some embodiments the spring 304 is constructed of non-conductive material, so that the plate 303 is not connected electrically to a current source. However, in some embodiments the spring 304 may be constructed of a conductive material.

In some embodiments the spring 304 may optionally be produced from several layers of spring, or from several spring fibers.

In some embodiments the spring 304 is optionally a metal spring, optionally a non-conductive spring, optionally a spring made of CRES 301 (Corrosion Resistant 301), Full Hard (material condition “Full Hard”).

In some embodiments the coil 308 is optionally wrapped around a bobbin 305.

Electrically conductive wire is optionally wound around a bobbin, in some embodiments optionally made of a plastic material, which potentially provides an ability to connect the electromagnet 300 accurately to one or more connector contact(s) with one or more contact 307 pin(s) or contact 307 shaft(s).

The contact(s) 307 may optionally be attached to a plastic bobbin during a molding process.

A potential benefit of the bobbin 305 shape includes a simple way to connect ends of electric wire of the coil 308 to the contact(s) 307.

It is noted that in some embodiments the spring 304 is constructed of non-conductive material, so that the plate 303 is not connected electrically to a current source. However, in some embodiments the spring 304 may be constructed of a conductive material.

FIG. 3B depicts a front view cross section of the bobbin 305 and the core 302a 302b.

The cross section of the bobbin 305 depicts the core 302a in a recess, or lumen, extending through the bobbin 305, and the core 302b in a trough or recess in the bobbin 305.

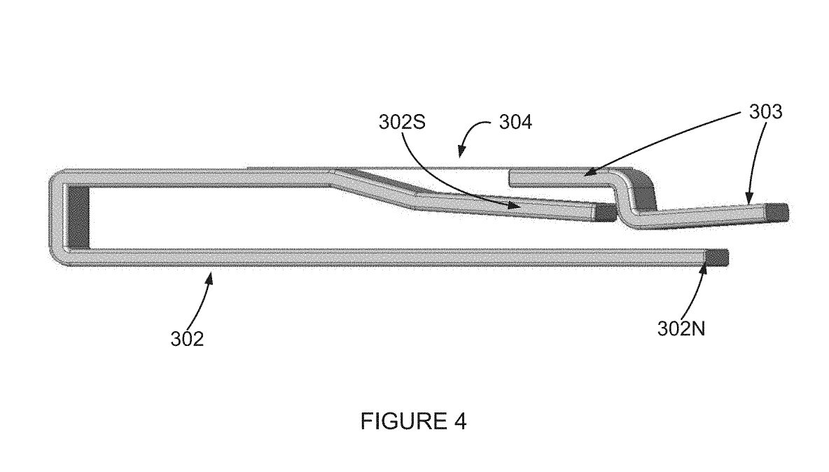

Reference is now made to FIG. 4, which is a simplified cross sectional drawing of an aspect of an example embodiment of the invention.

FIG. 4 depicts an example embodiment of a design of a core 302, a spring 304, and a plate 303, which together make up some components of an electromagnetic actuator as described with reference to FIGS. 2 and 3A. Design of the components potentially provides a benefit of simplifying assembly of a electromagnetic actuator as described with reference to FIGS. 2 and 3A. The components may simply be slipped into a coil (not shown in FIG. 4 but shown in FIGS. 2 and 3A) and/or into a recess (not shown in FIG. 4 but shown in FIG. 3B) in a bobbin (not shown in FIG. 4 but shown in FIGS. 3A and 3B).

A thickness of the core 302 may optionally be approximately 0.7 mm, although a range of 0.3 to 2.0 mm is contemplated.

A height of the core 302 may optionally be approximately 4.85 mm, although a range of 2.0 to 20 mm is contemplated.

A length of the core 302 may optionally be approximately 25.6 mm, although a range of 12 to 100 mm is contemplated.

A thickness of the plate 303 may optionally be approximately 0.7 mm, although a range of 0.3 to 2.0 mm is contemplated.

A thickness of the spring 304 may optionally be approximately 0.05 mm, although a range of 0.02 to 0.2 mm is contemplated.

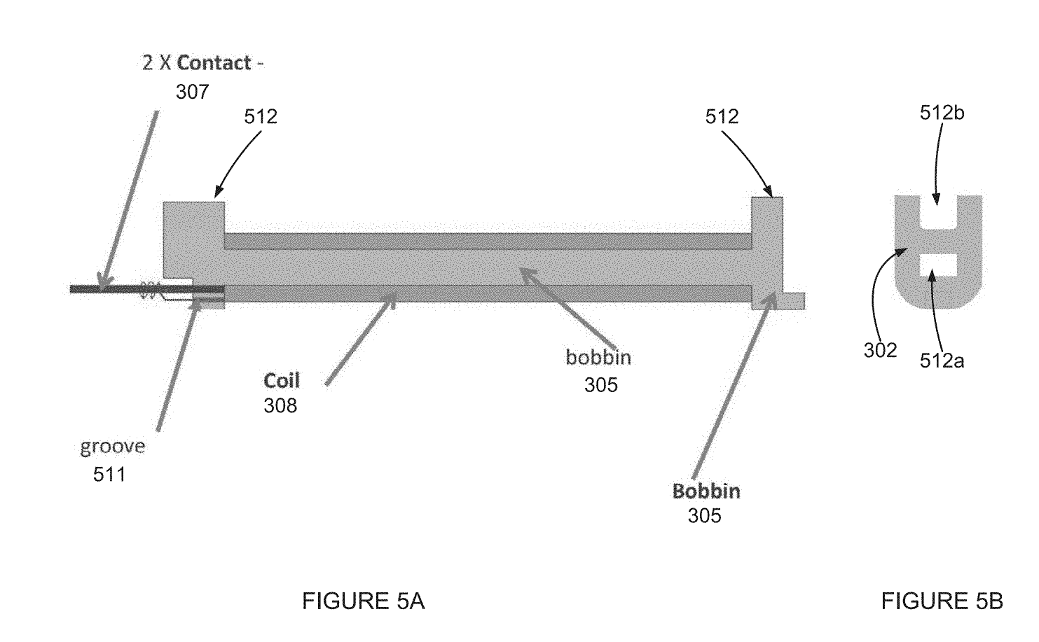

Reference is now made to FIGS. 5A and 5B, which are simplified cross sectional drawings of another aspect of an example embodiment of the invention.

FIG. 5A depicts an example implementation of the bobbin 305 design, and FIG. 5B depicts a cross section of the example implementation of the bobbin 305 design.

FIGS. 5A and 5B depict an example embodiment of a design of a bobbin 302, with supports 512 for two ends of a coil 308; a trough 512b in one of the supports 512 for one extension of a core, such as the extension of the core 302b depicted in FIGS. 3A and 3B; and a recess or lumen 512a through the bobbin 305, for another extension of a core, such as the extension of the core 302a depicted in FIGS. 3A and 3B.

In some embodiments the bobbin 512 optionally includes a groove 511, the groove 511 potentially easing connection of coil wire ends to the contacts 307. The connecting may optionally be done by soldering and/or welding and/or ultrasonic process. In some embodiments bobbin 305 material is selected so as to withstand soldering and/or welding temperatures, as is known in the art.

Some non-limiting examples of dimensions are provided below:

A thickness of the bobbin 305 walls may optionally be approximately 0.35 mm, although a range of 0.15 to 1.0 mm is contemplated.

A width of the bobbin 305 may optionally be approximately 3 mm, although a range of 1.5 to 6 mm is contemplated.

A height of the bobbin 305 may optionally be approximately 3.5 mm, although a range of 2 to 7 mm is contemplated.

In some embodiments a length of the bobbin is approximately 20.5 mm, although a range of 10 to 50 mm is contemplated.

### Potential Benefits of an Electromagnetic Actuator Constructed According to Example Embodiments of the Invention

The electromagnetic actuator provides a design suitable for exerting sideways magnetic attraction relative to a magnetic coil longitudinal axis.

The electromagnetic actuator can potentially provide a small linear movement, exerted with a strong force, using a small voltage.

A range of linear movement contemplated includes fractions of a millimeter, fractions of a centimeter, a centimeter or more, and several centimeters or more.

A force which may be expected from an example embodiment includes achieving a force of 1-10 grams by applying 5 volts.

Some non-limiting example parameters describing an electromagnetic actuator according to an embodiment of the invention include:

| | | | | Coil | Core | | Force- | Force- |
|---|---|---|---|---|---|---|---|---|
| | Coil | # of | R | Length | Cross | Voltage | Open | Close |
| Type | Diam. | Turns | (Ohms) | (mm) | Section | (V) | Newton | Newton |
| Air | 30 | 7000 | 1000 | 17 | 1.5 × 0.7 | 5 | 6.47E−4 | 39.5E−4 |
| Coil | | | | | | | | |
| Bobbin | 30 | 5700 | 1000 | 17.4 | 1.0 × 0.7 | 5 | 3.57E−4 | 30.4E−4 |
| Bobbin | 34 | 5200 | 1000 | 17.4 | 1.0 × 0.7 | 5 | 4.43E−4 | 38.0E−4 |

The above-mentioned Type parameter is listed as an electromagnetic actuator type, Air Coil—without a bobbin, or Bobbin—with a bobbin.

The above-mentioned Coil Diam parameter is a coil wire diameter listed in units of micrometer.

The above-mentioned R parameter is a total resistance parameter, listed in Ohms.

The above-mentioned Core Cross Section parameter is listed in units of mm×mm.

The above-mentioned Force Open parameter is listed at a gap of 1.1 mm.

The above-mentioned Force Close parameter is listed at a gap of 0.1 mm. The above-mentioned parameters refer to an electromagnet which has H×W×L dimensions of 5 mm×3 mm×26 mm respectively, although other sizes are optionally contemplated, such as 6×3.5×30 and 10 mm×5 mm×30 mm.

It is noted that the force exerted by such a relatively small electromagnet is considered large for the size. Embodiments of the invention are potentially energy efficient, and potentially especially useful for instances where energy is to be conserved, for example battery powered instances, for example cell phones or tablets and similar devices, as also mentioned below.

It is noted that the extent of movement of the plate achieved by such a relatively small electromagnetic actuator is considered large for the size. In the above example embodiment the plate has a range of movement of 1.1 mm, while the cross section of the electromagnetic in the direction of movement of the plate is 5 mm×3 mm, leading to a movement of up to 1.1 mm/3 mm=36% of a width of the electromagnetic actuator, or 1.1 mm/5 mm=20% of a height of the electromagnetic actuator.

Embodiments of the invention are potentially energy efficient, and potentially especially useful for instances where energy is to be conserved, for example battery powered instances, for example cell phones or tablets and similar devices, as also mentioned below.

It is noted that the efficiency of the electromagnetic actuator is potentially aided by the two-gap design of the actuator and/or by a relatively small amount of material in the core, which is relatively small for the force exerted.

It is noted that a plate according to the above example embodiment has a potential range of movement of approximately 1 mm, between Open and Close.

### Potential Applications

Some non-limiting examples of potential applications using an electromagnetic actuator constructed according to example embodiments of the invention are described below.

For example, when a need arises for densely packing electromagnetic actuators, which include an electromagnetic actuator, it is sometimes beneficial to construct the electromagnetic actuators in a direction perpendicular to a direction in which the electromagnetic actuators exert force and pull on a plate. One such non-limiting example includes electromagnetic actuators for arresting movement of hydraulically actuated rods in a color display panel in which pixel colors are controlled by the rods. Such an example is described in PCT Patent Publication Number WO 2013/144956 of Kraemer et al, the disclosures of which is hereby incorporated herein by reference.

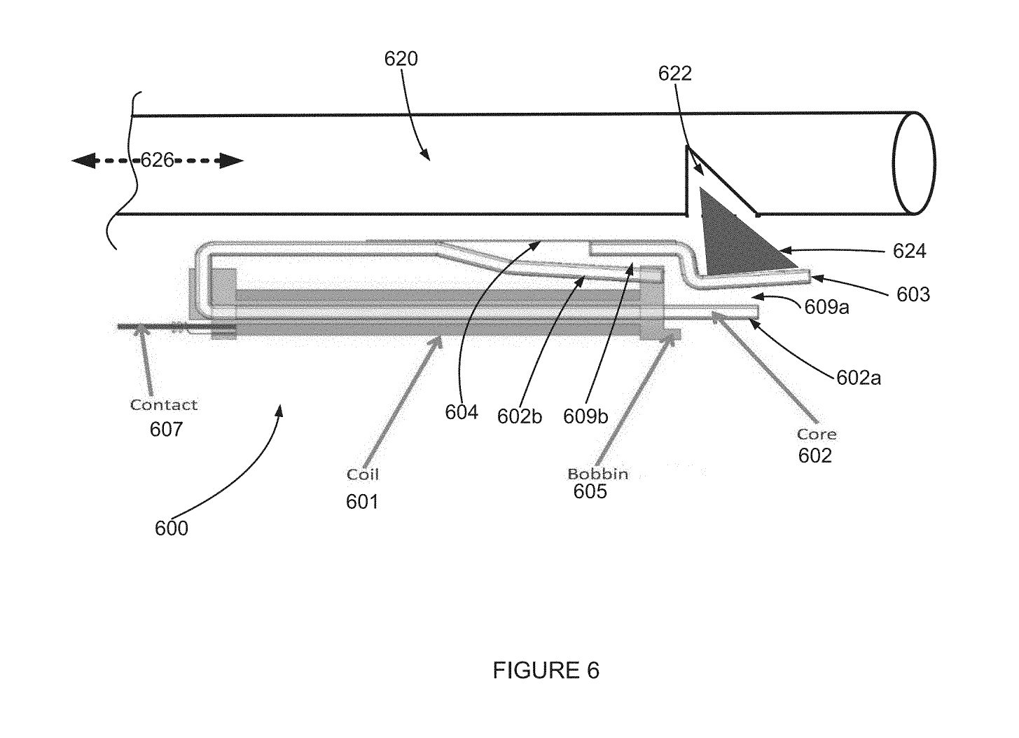

Reference is now made to FIG. 6, which is a simplified cross sectional drawing of another example embodiment of the invention.

FIG. 6 depicts an electromagnet 600 and a plate 603 according to an example embodiment of the invention being used for arresting movement of an adjacent sliding rod 600.

FIG. 6 depicts the electromagnet 600 configured to pull the plate 603 sideways, using both magnetic poles 602a 602b, across two gaps 609a 609b.

The electromagnet 600 includes a coil 601, a core 602, and the plate 603 attached to a spring 604, which together depict a example embodiment of an electromagnetic actuator.

When current flows through the coil 601, the plate 603 gets pulled across two gaps 609a 609b. The electromagnet 300 pulls the plate 303 across both gaps 309a 309b in a same direction approximately perpendicular to a longitudinal axis of the electromagnet 300.

An extension 624 is attached onto the plate 603, or, in some embodiments the plate 603 includes the extension 624 as part of the plate 603.

The extension 624 is made to move sideways by application of current to the coil. When the extension 624 moves sideways, the extension 624 may optionally serve to arrest or free the sliding rod 620 from sliding lengthwise along its axis 626, optionally by extending into a groove 622 in the rod 620. In some embodiments the extension 624 may be constructed of a material which exerts friction on the sliding rod 620, in which case the sliding rod 620 does not necessarily require a groove 622.

A potential benefit of a design of example embodiments of the invention include manufacture by slipping a U-shaped core into a coil, or slipping a long core into a coil and bending the core into a shape similarly to the core shapes described herein.

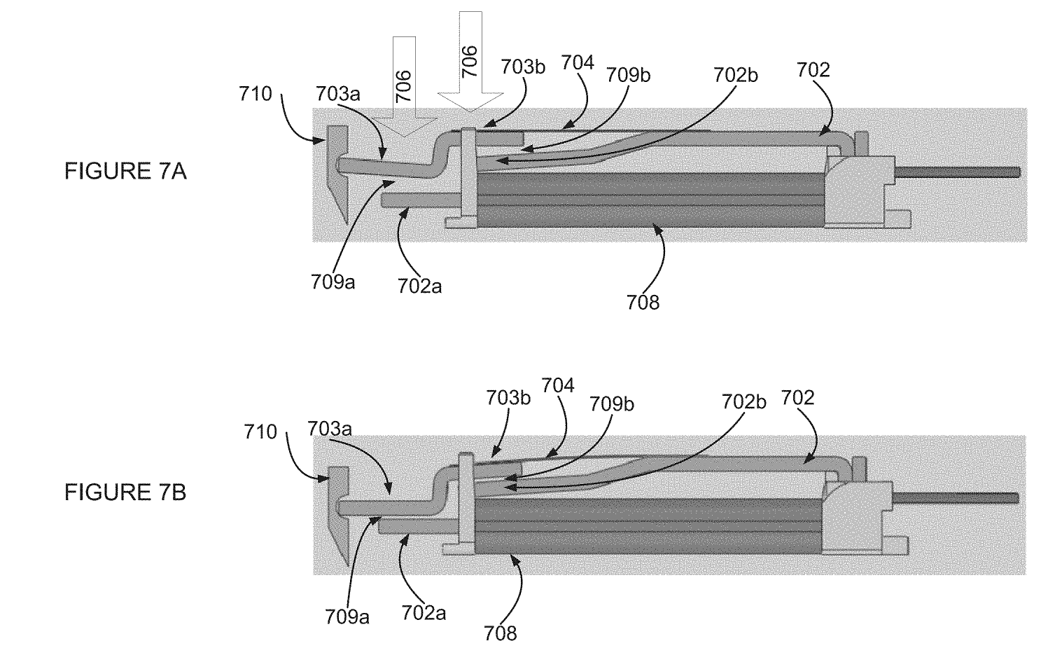

Reference is now made to FIGS. 7A and 7B, which are simplified cross sectional drawings of another aspect of an example embodiment of the invention.

FIGS. 7A and 7B depict an electromagnetic actuator configured to pull a mechanical component 710 sideways, using a plate which is pulled by both magnetic poles, across two gaps.

FIGS. 7A and 7B depict an electromagnet including a coil 708, and a core 702, and a plate 703 attached to a spring 704, which together depict an example embodiment of a electromagnetic actuator.

When current flows through the coil 708, the plate 703 gets pulled across two gaps 709a 709b; a first gap 709a between the plate 703 and one pole 702a of the core 702, and a second gap 709b between the plate 703 and an extension 702b of the core 702 which extends out of an opposite magnetic pole and folds back along the electromagnetic coil 708 toward the plate 703. The electromagnet pulls the plate 703 across both gaps 709a 709b in a same direction approximately perpendicular to a longitudinal axis of the electromagnet as depicted by two arrows 706 in FIGS. 7A and 7B.

FIG. 7A depicts the plate 703a 703b away from the magnetic poles 702a 702b, and FIG. 7B depicts the plate 703a 703b closer to the magnetic poles 702a 702b, potentially touching the magnetic poles 702a 702b.

FIG. 7A depicts the mechanical component 710 at a first position, and FIG. 7B depicts the mechanical component 710 at a second position. The mechanical component 710 was moved from the first position and the second position by the plate 703, in FIG. 7 by the portion 703a of the plate 703, inserted in a notch in the mechanical component 710.

For example, a potential implementation of electromagnetic actuator as described herein includes a locking mechanism, where locking pins are optionally operated by using the electromagnetic actuator to move the locking pins with a small investment of power.

For example, mobile phone cameras are typically built with an optic axis perpendicular to the mobile phone plane. Mobile phones are thin, so if adjustable focus mobile phone cameras are to be built, an electromagnetic actuator as described herein potentially provides a benefit of taking up little depth, and being able to be packaged sideways, approximately perpendicularly to a direction of travel of a focusing lens.

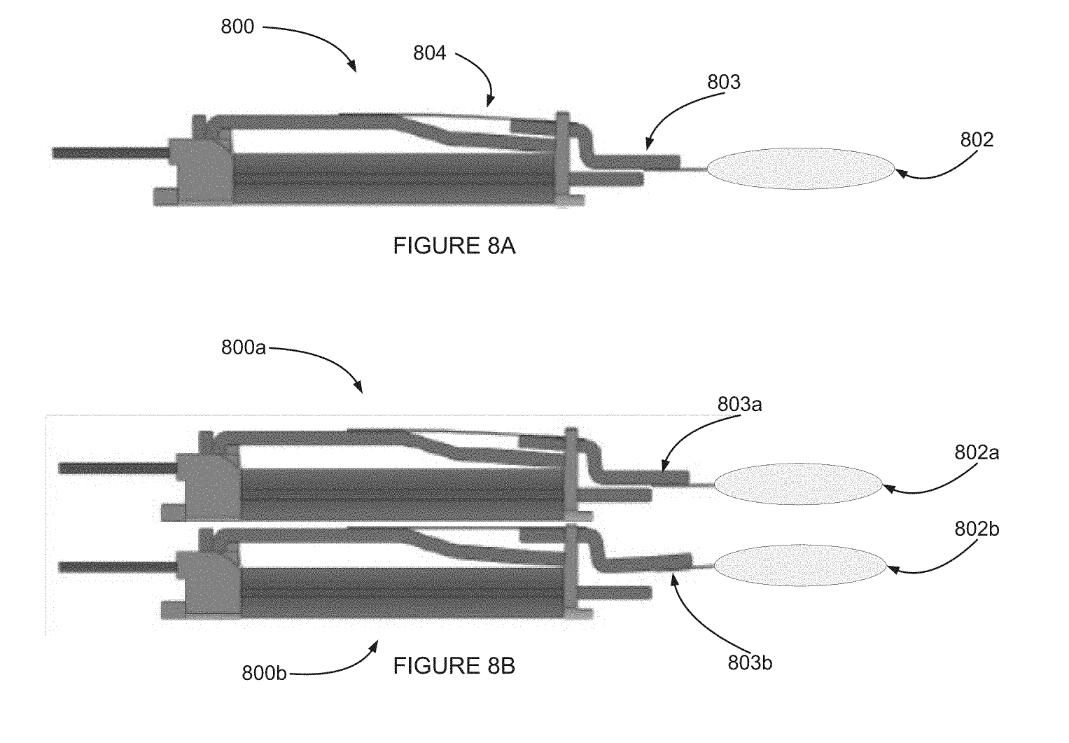

Reference is now made to FIGS. 8A and 8B, which are simplified cross sectional drawings of another aspect of an example embodiment of the invention.

FIG. 8A depicts an example embodiment of an electromagnetic actuator 800 with a lens 802 attached to a plate 803. Depending on voltage applied to the electromagnetic actuator 800, or on current caused to flow through the electromagnetic actuator 800, the lens 802 may be controlled to move a varying amount up or down. A spring 804 pulls the lens up, and electromagnetic force pulls the lens down. Balancing the electromagnetic force by controlling electric power applied to the electromagnetic actuator enables controlling to vertical position of the lens 802.

The electromagnetic actuator 800 plus lens 802 combination depicted in FIG. 8a enables packaging a focus controller in a thin package, using little poser, and producing relatively large forces for the power used, by using two portions of a plate attracted to two poles of an electromagnet.

FIG. 8B depicts an example embodiment of two electromagnetic actuators 800a 800b with two lenses 802a 802b attached to two plates 803a 803b. Depending on voltage applied to one or both of the electromagnetic actuators 800a 800b, or on current caused to flow through the electromagnetic actuators 800a 800b, the two lenses 802a 802b may each be separately and individually controlled and positioned.

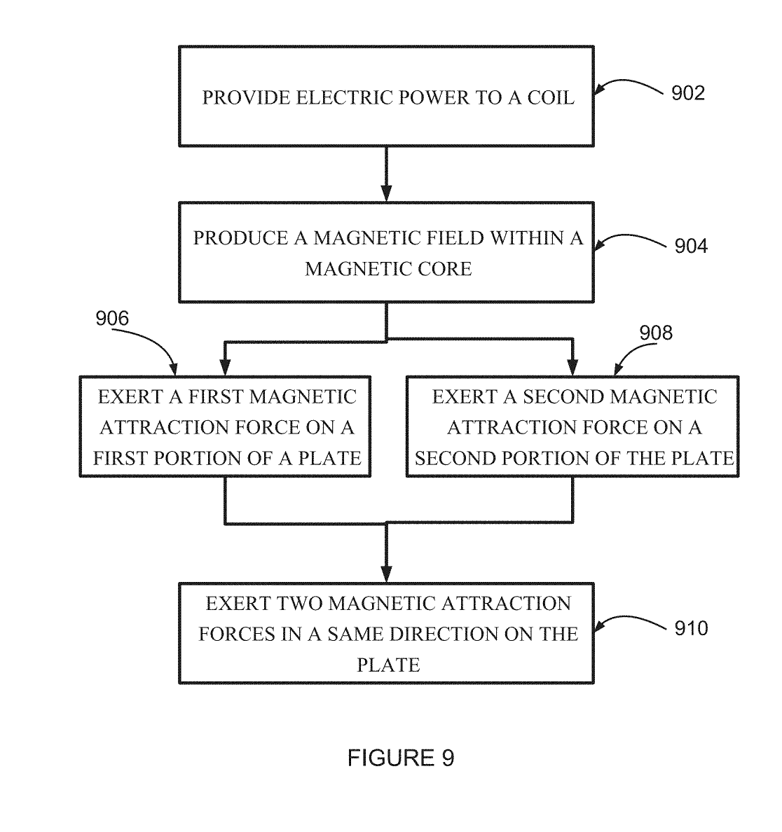

Reference is now made to FIG. 9, which is a flow chart illustration of a method of operating an electromagnetic actuator according to an example embodiment of the invention.

The method of FIG. 9 includes:

providing electric power to a coil (902);

producing a magnetic field within a magnetic core (904);

a first portion of the magnetic core, extending from a first face of the coil, exerting a first magnetic attraction force on a first portion of a plate (906); and

a second portion of the magnetic core, extending from a second face of the coil, exerting a second magnetic attraction force on a second portion of the plate (908),

wherein the first magnetic attraction force and the second magnetic attraction force are in a same direction,

thereby exerting two magnetic attraction forces in a same direction on the plate (910).

It is expected that during the life of a patent maturing from this application many relevant materials for electromagnet cores and for springs will be developed and the scope of the terms “core” and “spring” are intended to include all such new technologies a priori.

As used herein the terms “approximately” and “about” refer to ±50%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An electromagnetic actuator device, the device comprising:
an electromagnet comprising:
a coil; and
a magnetic core comprising:
a first portion extending from a front face of the coil; and
a second portion extending from a back face of the coil bending back along the coil toward the front face of the coil; and
a plate placed such that a first portion of the plate parallels the first portion of the magnetic core and a second portion of the plate parallels the second portion of the magnetic core.

2. A device according to claim 1 in which the second portion of the magnetic core extends from a back face of the coil and folds back along the coil toward the front face of the coil.

3. A device according to claim 1 in which the plate is arranged to be pulled in a direction perpendicular to a longitudinal axis of the coil.

4. A device according to claim 1 in which the plate is connected to the electromagnet by a spring, which is configured to keep the plate separate from the magnetic core.

5. A device according to claim 1 in which the second portion of the magnetic core extends from the back face of the coil and bends toward the front face of the coil in a direction parallel to a longitudinal axis of the electromagnet.

6. A device according to claim 1 in which the first portion of the plate comprises at least a fifth of the plate length.

7. A device according to claim 1 in which the second portion of the plate comprises at least a fifth of the plate length.

8. A device according to claim 1 in which the first portion of the plate is positioned across a first gap from the first portion of the magnetic core and the second portion of the plate is positioned across a second gap from the second portion of the magnetic core.

9. A device according to claim 8 in which the first gap is equal in width to the second gap.

10. A device according to claim 8 in which the first gap is unequal in width to the second gap.

11. A device according to claim 8 in which the first portion of the plate is substantially parallel to the first portion of the magnetic core and the second portion of the plate is substantially parallel to the second portion of the magnetic core.

12. (canceled)

13. A device according to claim 1 in which the plate has a range of movement of at least 35% of a dimension of the electromagnetic actuator in the direction of movement.

14. A device according to claim 1 in which the plate comprises a zigzag shape in which a first portion of the zigzag shape is the first portion of the plate and a second portion of the zigzag shape is the second portion of the plate.

15. A device according to claim 14 in which a length of a middle portion of the zigzag shape, connecting the first portion and the second portion, has a length greater than a difference between a distance of the first portion from a longitudinal axis of the coil and a distance of the second portion from a longitudinal axis of the coil.

16. A device according to claim 1 and further comprising a bobbin on which the coil is wound, the bobbin comprising a lengthwise lumen, through which the core passes.

17. A device according to claim 16 in which the bobbin further includes a trough on a front face, at the front face end of the coil, for accepting the second extension of the magnetic core.

18. A device according to claim 1 in which the electromagnet achieves a force of at least 6×10⁻⁴ Newton exerted on the plate when a voltage of 5 volts is applied to the coil.

19. A device according to claim 18 in which the electromagnet has H×W×L dimensions smaller than 10 mm×5 mm×30 mm respectively.

20. An electromagnetic actuator device, the device comprising:
an electromagnet comprising:
a coil; and
a magnetic core comprising:
a first portion extending from a front face of the coil; and
a second portion extending from a back face of the coil bending back along the coil toward the front face of the coil; and
a zigzag shaped plate placed such that a first leg of the zigzag shaped plate parallels the first portion of the magnetic core and a second leg of the zigzag shaped plate parallels the second portion of the magnetic core.

21. A method of operating an electromagnetic actuator, comprising:
providing electric power to a coil;
producing a magnetic field within a magnetic core;
a first portion of the magnetic core, extending from a first face of the coil, exerting a first magnetic attraction force on a first portion of a plate; and
a second portion of the magnetic core, extending from a second face of the coil, exerting a second magnetic attraction force on a second portion of the plate,
wherein the first magnetic attraction force and the second magnetic attraction force are in a same direction,
thereby exerting two magnetic attraction forces in a same direction on the plate.
